(19) United States
(12) Patent Application Publication
(10) Pub. No.: US 2003/0163436 A1
(43) Pub. Date: Aug. 28, 2003

(54) Neuronal network for modeling a physical system, and a method for forming such a neuronal network

(76) Inventor: Jost Seifert, Schliersee (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/340,847

(22) Filed: Jan. 13, 2003

(30) Foreign Application Priority Data
Jan. 11, 2002 (DE) 102 01 018.8

(51) Int. Cl. G06N 3/067; G06N 3/063; G06N 3/06; G06F 15/18; G06G 7/00; G06E 3/00; G06E 1/00

(52) U.S. Cl. 706/26; 706/31

(57) ABSTRACT

A neuronal network for modeling an output function that describes a physical system using functionally linked neurons (2), each of which is assigned a transfer function, allowing it to transfer an output value determined from said neuron to the next neuron that is functionally connected to it in series in the longitudinal direction (6) of the network (1), as an input value. The functional relations necessary for linking the neurons are provided within only one of at least two groups (21, 22, 23) of neurons arranged in a transverse direction (7) and between one input layer (3) and one output layer (5). The groups (21, 22, 23) include at least two intermediate layers (11, 12, 13) arranged sequentially in a longitudinal direction (5), each with at least one neuron.

### BACKGROUND AND SUMMARY OF THE INVENTION

This application claims the priority of Application No. 102 01 018.8, filed Jan. 11, 2002, in Germany, the disclosure of which is expressly incorporated by reference herein.

The invention relates to a neuronal network for modeling a physical system using a computer program system for system identification, and a method for forming such a neuronal network, wherein the invention can be used for physical systems that are dynamically variable.

Systems that are suitable for application with this network are those that fall within the realm of movable objects such as vehicles, especially aircraft, and systems involving dynamic processes such as reactors and power plants, or chemical processes. The invention is especially well suited for use in modeling vehicles, especially aircraft, using aerodynamic coefficients.

In a system identification process for the formation of analytical models of a physical system, it is important to reproduce the performance characteristics of the system with its inputs and outputs as precisely as possible, in order that it may be used, for example, in simulations and for further testing of the physical system. The analytical model is a mathematical model of the physical system to be copied and should produce output values that are as close as possible to those of the real system, with the same input values. The following are ordinarily required for the modeling of a physical system:

Pairs of measured input and output values

A model structure

A method for determining characteristic values

In some processes, estimated initial values for the characteristic values.

To simulate aircraft using aerodynamic coefficients, a determination of aerodynamic coefficients is necessary, which, in the current state of the art, is accomplished via the so-called “Equation Error Method” and the so-called “Output Error Method”.

In these methods, the performance characteristics of the system are simulated using linear correlations, wherein a precise understanding of the model and an undisrupted measurement are ordinarily assumed. These methods carry with them the following disadvantages:

a) Ordinarily, a linear performance characteristic describing an initial state is required. Consequently, it is difficult to reproduce a highly dynamic performance characteristic correctly for a system, since state-dependent characteristic values are no longer in linear correlation with the initial state.

b) Relevant characteristic values can be identified only for particular portions of the measured values (e.g., aircraft maneuvers). This results in high data processing costs.

c) A convergence of the methods can be impeded by sensitivity to outdated measured data.

As an alternative to these established methods, neuronal networks are used in system modeling. Due to the relatively high level of networking of the neurons, multi-layered, forward-directed networks are used which are similar to a black-box, whereby a characteristic value of the modeled system cannot be localized. This means that internal dimensions of the network cannot be assigned specific physical effects; hence, they cannot be analyzed in detail. This type of analysis is important, however, for the formulation of statements regarding the general effectiveness of the overall model. Due to this black-box character, neuronal networks have thus far not been used for system identification.

It is the object of the invention to create a neuronal network for modeling a physical system using a computer program system for system identification, and a method for constructing said network. The network must be robust and permit the determination of characteristic values for the modeled system.

According to the invention, a neuronal network is provided for modeling an output function that describes a physical system, consisting of neurons that are functionally connected to one another. A transfer function is assigned to each of the neurons, allowing them to transfer the output value determined from that neuron to the neuron that is functionally connected to it in sequence, in the longitudinal direction of the network, as an input value. The functional relations for connecting the neurons are provided within only one of at least two groups of neurons that are arranged in a transverse direction between an input layer and an output layer, wherein the groups include at least two intermediate layers arranged sequentially in a longitudinal direction and have at least one neuron each. In particular, the subfunction coefficients in the form of untrainable links between a group of neurons and the output neurons of the entire neuronal network are considered. They are provided as links between the input layer and each group of untrainable input links.

With the structure of the neuronal network provided in the invention it is possible to assign specific physical effects to individual neurons, which is not possible with the current state of the art neuronal networks that lack the system-describing model structure. In general, the neuronal network specified in the invention ensures greater robustness than outdated measured data, and furthermore offers the advantage over the “Equation Error Method” and the “Output Error Method” that functions to describing the system to be modeled, allowing an improved manipulation of the invention when used on similar systems.

According to the invention, a neuronal network is provided for use in the formation of analytical models of physical systems, wherein the dynamic and physical correlations of the system can be modeled in a network structure. To this end, it is necessary that the output of the system be comprised of a sum of a number of parts (at least two), which are calculated from the input values. For each part, a physical effect (e.g., the stabilization of a system) can be defined.

The method specified in the invention offers the following advantages: With the use of neuronal networks as described in the invention, a greater robustness is achieved over outdated measured data, and the analytical model is not limited to linear correlations in the system description, since output values for all input values within a preset value range are interpolated or extrapolated in a non-linear manner. Furthermore, with the use of the neuronal network specified in the invention, a generalization can be made, i.e., general overall trends can be derived from erroneous measured data.

Furthermore, due to the structure of the neuronal network specified in the invention, specific expert knowledge regarding the modeled physical system can also be incorporated via a specific network structure and predefined value ranges.

Other objects, advantages and novel features of the present invention will become apparent from the following detailed description of the invention when considered in conjunction with the accompany drawings.

### BRIEF DESCRIPTION OF THE DRAWINGS

The invention will be described with reference to the attached figures, which show:

FIG. 1 is an exemplary embodiment of a neuronal network being used to form an analytical model of a physical system being reproduced, as specified in the invention,

FIG. 2 is a representation of a neuronal network according to the general state of the art.

### DETAILED DESCRIPTION OF THE PREFERRED EMBODIMENT

The neuronal network specified in the invention for use in modeling an output function that describes a physical system is comprised of functionally connected neurons (2), each of which is assigned a transfer function, allowing it to transfer the output value determined from that neuron, as an input value, to the neuron 2 that in the longitudinal direction 6 of the network 1 is functionally connected to it as the next neuron. In the following description, terms ordinarily associated with neuronal networks such as layers, neurons, and links between the neurons will be used. Additionally, the following nomenclature will be used:

Oₗ Output of a neuron from the preceding layer l,

Wₗⱼ Trainable link weight between two layers l and j,

ƒⱼ Transfer function of a neuron in the subsequent layer j.

| Wₗⱼ | Wₗⱼ |
|---|---|
| O₁ → Δ ƒⱼ = tanh(Σoₗw_{l]}) | O₁ → Ø ƒⱼ = Σoⱼwₗⱼ |
| Neuron with non-linear transfer function | Neuron with linear transfer |
| | function |

The neuronal network specified in the invention is based upon analytical equations for describing the performance characteristics of the system, dependent upon input values. These equations comprise factors and functions of varying dimensions. These functions can be linear or non-linear. To describe the system in accordance with the method specified in the invention using a neuronal network, these functions and their parameters must be established, wherein neurons with non-linear or linear transfer functions are used.

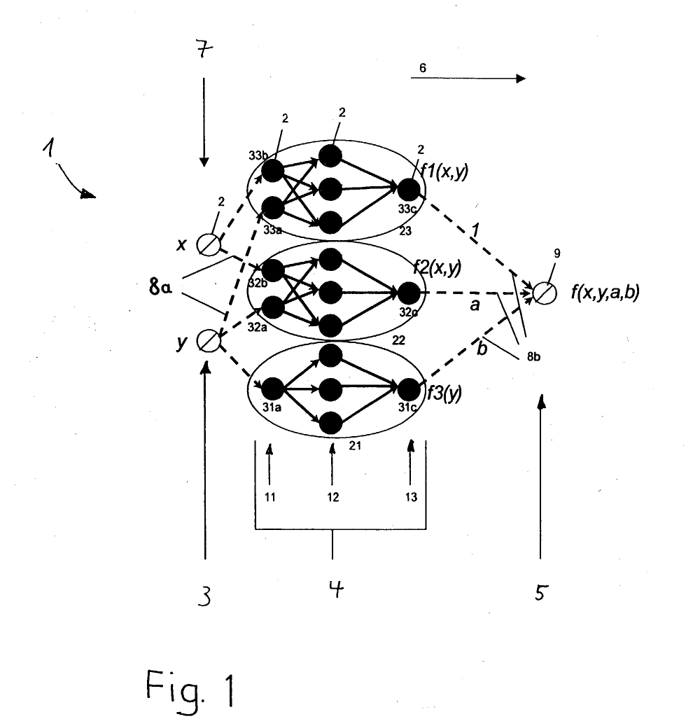

One exemplary embodiment of a neuronal network, as specified in the invention, is represented in FIG. 1 for an aerodynamic model describing the longitudinal movement of an aircraft. According to the invention, multilayer feed-forward networks (Multi Layer Perception) are used. With the network structure specified in the invention, and with the modified optimization process, a separation of the physical effects and an assignment of these effects to prepared groups take place. Each group represents a physical effect and can, following a successful training of the entire network, be analyzed in isolation. This is because a group can also be isolated from the overall network, and, since both inputs and outputs can be provided for any input values, output values for the group can also be calculated.

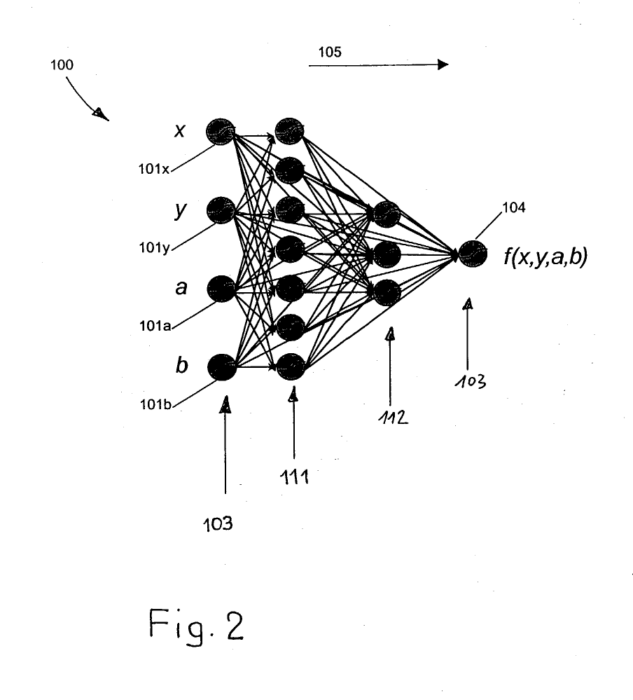

A neuronal network according to the current state of the art, with neurons having a non-linear transfer function for the construction of a function ƒ having four input values x, y, a, b is represented in FIG. 2. The illustrated neuronal network 100 is provided with an input layer 101 with input neurons 101a, 101b, 101x, 101y, an output neuron 104, and a first 111 and a second 112 intermediate layer. The number of intermediate layers and neurons that are ordinarily used is based upon pragmatic values and is dependent upon the complexity of the system to be simulated. In the traditional approach, the neurons are linked to one another either completely or in layers. Typically, the input neurons are on the left side, and at least one output neuron is on the right side. Neurons can generally have a non-linear function, e.g., formed via the tangent hyperbolic function, or a linear transfer function. The neurons used in these figures are hereinafter referred to using the corresponding reference symbols. Due to its cross-linked structure, these parts cannot determine or solve the system equation for the parameters.

In accordance with the invention, to solve an equation to describe a physical system, a neuronal network having a specific architecture is used (see FIG. 1). While intermediate layers arranged sequentially as viewed in the longitudinal direction 6 of the network 1, which hereinafter are referred to in combination as a group layer 4, are retained, at least two additional groups of neurons are formed, arranged in a transverse direction 7. In contrast to the traditional arrangement, the formation of groups allows the partial subfunctions to be considered individually.

According to the invention, the functional relations for connecting the neurons are provided within only one of at least two groups 21, 22, 23 of neurons, arranged in a transverse direction 7 and between an input layer 3 and an output layer 5, wherein the groups 21, 22, 23 comprise at least two intermediate layers 11, 12, 13 arranged sequentially in a longitudinal direction 5, and comprising at least one neuron. Thus one neuron in an intermediate layer is connected to only one neuron in another, adjacent intermediate layer, via functional relations that extend in the longitudinal direction 6 of the network 1, with these neurons belonging to one of several groups of at least one neuron each, arranged in a transverse direction 7. The groups of neurons are thus isolated, i.e., the neurons of one group of neurons are not directly connected to the neurons of another group. Within a group of neurons, any number of intermediate layers may be contained.

The groups of neurons used in the invention comprise at least one input layer 3 having at least one input neuron (reference figures x and y; the references x and y are also used for the corresponding variables or input values), and at least one output layer 5 having at least one output neuron 9.

The number of neuron groups to be formed in accordance with the invention is preferably equal to the number of subfunctions in the functional equation being used to describe the system being simulated.

Advantageously, in the architecture specified in the invention, the subfunction coefficients are integrated in the form of untrainable input links behind the group layer. In this way, the number of links, and thus also the time required for training and calculating, is reduced. In state-of-the-art neuronal networks, in contrast, these subfunction coefficients would be in the form of input neurons (FIG. 2).

The input and output neurons in the neuronal network are preferably linear, in order to pass on the input values, unchanged, to the groups, and in order to simply add up the outputs from the groups.

A group of neurons is connected to the input neurons via untrainable links, and to the output neurons of the entire neuronal network via untrainable input links.

With the untrainable input link, the output of a group of neurons can still be multiplied by a factor (e.g., 12(x, y) multiplied by a).

The untrainable input links are advantageously used to assign physical effects to prepared groups. These links enable the calculated total error at the network output to be split up into the individual parts from the groups, during the optimization process (training). Thus, for example, with an input link having the value of zero, this group cannot have contributed to the total error. Hence, the value of zero is calculated as a back-propagated error in accordance with the back-propagation algorithm. The error-dependent adjustment of the weights within this group is thus avoided. Only those groups whose untrainable input links are not equal to zero are adjusted.

Below, this network architecture is described by way of example, using a physical system having the following mathematical approximation:

ƒ(x,y,a,b)=ƒ2(x,y)+ƒ2(x,y)·a+ƒ3(y)·b (1)

This type of function can be used to describe a multitude of physical systems, such as the formula given in the equation (2) for the longitudinal movement (pitch momentum) of an aircraft:

C_{M}=C_{M0}(a, Ma)+C_{Mη}(a, Ma)·η+C_{Mq}(Ma)·q (2)

In the representation of the equation (1), the coefficients are the functions ƒ1, ƒ2 and ƒ3, and in the representation of the equation (2) they are C_{M0}, C_{Mη}, and C_{Mq}. These individual coefficients are generally non-linearly dependent upon the angle of pitch a and sometimes upon the Mach number Ma.

In this:

| | |
|---|---|
| C_{M} | = pitch momentum coefficient |
| C_{M0}(a, Ma) | = zero momentum coefficient, dependent upon the pitch |
| | angle a and the Mach number Ma; |
| C_{Mη}(a, Ma) | = derivative for the increase in pitch momentum |
| | resulting from elevator control deflection; it is |
| | dependent upon the pitch angle a and the Mach |
| | number Ma, and must be multiplied by η |
| C_{Mq}(Ma) | = derivative for stabilization of pitch; it is dependent |

upon the Mach number Ma, and must be multiplied by the pitch rate q.

FIG. 1 shows a neuronal network 1 formed from neurons 2 and based upon the starting equation (1), used by way of example, with said network comprising an input layer 3 and an output layer 5, and several, at least two, groups in the group layer 4. Within one group, a first 11, a second 12, and a third 13 intermediate layer are arranged—each as a component of the group layer 4. The number of intermediate layers that are used is dependent upon the order of the function to be approximated, with which the simulated system is mathematically described. Ordinarily one to three intermediate layers are used.

According to the invention, groups of neurons are formed in the group layer, arranged in the network 1 in a transverse direction 7, wherein the number of neuron groups to be formed in accordance with the invention is preferably equal to the number of subfunctions in the functional equation being used to describe the system being simulated. In the equation (1) and/or the equation (2), there are three subfunctions as their specialization. Accordingly, in the embodiment shown in FIG. 1, three neuron groups 21, 22, 23 are provided. In this manner, with the formation of groups arranged in a transverse direction, the given subfunctions, which in the example of the equation (1) are the functions ƒ1, ƒ2, and ƒ3, can be viewed in isolation. To this end, the first intermediate layer 11 is used as an input layer and the last intermediate layer 13 is used as an output layer.

In the neuronal network formed for the equation (1) in FIG. 1, the subfunction coefficients are the coefficients 1, a and b, and are integrated into the overall network in the form of untrainable input links 8b; i.e., the links between the last intermediate layer 13 of a group and the output layer 5 are acted upon with the functional coefficients. In this manner, the number of links, and thus also the time required for training and calculation, is reduced. The input and output neurons of the group, in other words the input layer 3 and the output layer 5, should preferably be linear, in order to allow the input values to be passed on, unchanged, to the neurons of the intermediate layers 11, 12, 13, and to allow the output values for the neuron groups to be simply added up.

The neuron groups 21, 22, 23 used in the invention comprise a first intermediate layer, or input intermediate layer 11 in the group layer 4, with at least one input neuron 31a or 32a, 32b, or 33a, 33b. A last intermediate layer or output intermediate layer 13 comprises at least one output neuron 31c or 32b or 33c. The neuron groups 21, 22, 23, which are functionally independent of one another due to the functional correlations in the transverse direction 7, are isolated from one another, i.e., the neurons of one neuron group are not directly linked to the neurons of another neuron group. This does not apply to the functional link to the input layer 3 and the output layer 5. Any number of intermediate layers can be contained within a neuron group. In the exemplary embodiment shown in FIG. 1 three intermediate layers 12 are arranged. This means that, according to the invention, the functional relations for linking the neurons are provided within only one of at least two groups of neurons 21, 22, 23 that are arranged in a transverse direction 7 and between an input layer 3 and an output layer 5. Each group 21, 22, 23 comprises at least two intermediate layers 11, 12, 13 arranged sequentially in a longitudinal direction 6, each with at least one neuron. Thus, one neuron in an intermediate layer is connected to only one neuron in another, adjacent intermediate layer, via functional relations that extend in a longitudinal direction 6 in the network 1, when these neurons belong to one of several groups arranged in a transverse direction 7 and containing at least one neuron each.

With the neuronal network specified in the invention, the internal terms ƒ1, ƒ2, ƒ3 of the equation (1), and/or the terms C_{M0}(a,Ma), C_{Mη}(a,Ma), C_{Mq}(Ma) in the more specialized equation (2) can be determined using the network parameters (link weights), in order to test the model for the proper performance characteristics with untrained input values. For example, with the equation (2) the term C_{Mq}(Ma) should always be negative, because it represents the stabilization of the system. These analytical possibilities are achieved via the architecture of the neuronal network used in accordance with the invention (see FIG. 1).

The method for adjusting or defining the neuronal network specified in the invention will now be described in greater detail:

To form models of dynamic systems, analytical equations designed to describe the system's performance characteristics, dependent upon input values, are set up. One example of such an equation is formulated above in the equation (1). These equations comprise factors and functions of varying dimensions. These functions can be linear or non-linear. In a further step in the method specified in the invention, these functions and their parameters that describe the system being modeled must be determined. The structure of the neuronal network is then established according to the above-described criteria. One exemplary embodiment of a neuronal network used in accordance with the invention is represented in FIG. 1 for an aerodynamic model that describes the longitudinal movement of an aircraft. The architecture of the neuronal network 1 is structured analogous to the mathematical function ƒ(x,y,a,b), wherein untrainable links 8a are provided between the input layer and the first group layer 11, and untrainable input links 8b are provided between the last group layer 13 and the output layer 5.

A training phase follows, during which the network is adjusted to agree with the system being simulated. In this, the input and output values for the system (in this case an aircraft) are measured. For the aerodynamic example, the mechanical flight values α, Mα, η, q and C_{M} are measured or calculated using mechanical flight formulas. From the measured data, a training data set is established for the neuronal network, comprised of a number of value pairs, each containing four input values (α, Mα, η, q) and one output value (C_{M}). Iterative processes, e.g., the method of descent by degree (back propagation), can be used in the learning process. In this, to optimize the neuronal network, the trainable link weights w_{y} (indicated here as arrows) are ordinarily adjusted such that the neuronal network will supply the best possible output for all the measured data.

An optimization process is then implemented using the training data set to establish the link weights for the neuronal network. In this manner, the parts ƒ1, ƒ2 and ƒ3 can be represented exclusively in the groups provided for this purpose.

Prior to optimization, all link weights can be set as random values, preferably within the range [−1.0:+1.0]. If preset values exist for the terms ƒ1, ƒ2, and ƒ3, the groups may also be individually pretrained. To accomplish this, a group must be considered a closed neuronal network, and the optimization algorithm must be used on this group alone.

The optimization of the link weights in accordance with the known back-propagation algorithm is accomplished via the following steps:

The values for the inputs into the network are adopted from the training data set. In step 1, in addition to the neurons in the input layer 3, the input links 8b must also be set to the input values from the training data set.

The network is calculated starting with the input layer and continuing to the output layer. In this, the activation of each neuron is calculated based upon the preceding neurons and links.

The activation of the output neurons is compared with the reference value from the training data set. Network error is calculated from the difference.

From the network error, the error in each neuron is calculated, in layers starting from the back and traveling forward, wherein the links can also function as inputs.

Dependent upon the error of one neuron and its activation, a weight change in the links to adjacent neurons is calculated, wherein the links can also function as inputs.

Finally, the weight changes are added to the proper link weights, wherein the weight changes are not added to the untrainable links 8a and the untrainable input links 8b.

Following the successful training of the neuronal network, each group ƒ1, ƒ2 and ƒ3 can be analyzed in isolation. This is because each group can be viewed as a closed neuronal network. In this, an input value y for the neuron 31a can be selected, and then this group can be calculated up to its output neuron 31c. The output neuron 31c of the group 21 then contains the functional value ƒ3(y).

For the aerodynamic example this means that:

The internal parts C_{Ma}(a,Ma), C_{Mη}(a,Ma), and C_{Mq}(Ma) can be provided to the output neurons 31c, 32c, 33c of the three neuron groups following calculation of the neuronal network 1.

The processes described, especially the process for training and optimizing the neuronal network specified in the invention, are intended especially for implementation in a computer program system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A neuronal network for use in modeling a physical system mathematically defined by a functional equation having summation terms having subfunctions and subfunction coefficients, said network comprising:
an input layer;
an output layer; and
a group layer, said group layer including at least two groups of neurons, wherein the number of groups of neurons is equal to the number of subfunctions in the functional equation being used to describe the system being modeled, and wherein the subfunction coefficients are arranged in the form of untrainable input links, after an output neuron in a respective group.

2. The neuronal network in accordance with claim 1, wherein the input and output layers include respective input and output neurons which are linear, in order to allow a transfer of input values, unchanged, to the neurons in a first layer of a group, and in order to avoid limiting the value range for the output of the neuronal network.

3. The neuronal network in accordance with claim 1, further including fixed value untrainable links between the neurons in the input layer and the first layer in a group, wherein said fixed value is determined during the training of the neuronal network.

4. The neuronal network in accordance with claim 1, further including an untrainable input link for the multiplication of the output of a group with a predetermined factor.

5. The neuronal network in accordance with claim 1, wherein the neuronal network is used to set up a simulation model.

6. The neuronal network in accordance with claim 1, wherein the neuronal network is analyzed by viewing one group as an isolated, neuronal network, wherein a first intermediate layer becomes the input layer and a last intermediate layer becomes the output layer.

7. The neuronal network in accordance with claim 1, wherein one group is trained in isolation, in which only link weights of a group are modified, using a training data set and an optimization process.

8. The neuronal network in accordance with claim 1, wherein a value range of a group is defined via a suitable selection of a transfer function for the output neuron of a group.

9. A neuronal network for use in modeling an output function that describes a physical system, said network comprising functionally connected neurons, each of which is assigned a transfer function, allowing transfer of a determined output value as an input value to a next neuron functionally connected in series, in the longitudinal direction of the network, wherein functional relations for linking the neurons are provided within only one of at least two groups of neurons, arranged in a transverse direction between an input layer and an output layer, and wherein each of the at least two the groups of neurons comprise at least two intermediate layers, arranged sequentially in a longitudinal direction, each of said at least two intermediate layers having at least one neuron, wherein the subfunction coefficients are considered in the form of untrainable links between a neuron group and the output layer neurons in the entire neuronal network, and are provided as links between the input layer and each one of a group of untrainable input links.

10. The neuronal network for modeling an output function that describes a physical system in accordance with claim 9, wherein a number of neuronal groups is equal to a number of subfunctions in a functional equation that describes the system being simulated.

11. The neuronal network for modeling an output function that describes a physical system according to claim 9, wherein the input layer of neurons and the output layer of neurons of the neuronal network are linear.

12. A method for setting up a neuronal network in accordance with claim 1, comprising:
adopting the values for the input into the network from a training data set;
registering the input neurons and the input links with said adopted values;
calculating the neuronal network from the input layer up to the output layer, wherein an activation of each neuron is calculated dependent upon preceding neurons and links;
comparing said neurons with a reference value from the training data set, and calculating the network error from the difference in order to activate the output neurons, wherein the error for each neuron is calculated from the network error, in layers from the back to the front;
calculating the weight change in links to adjacent neurons, dependent upon the error of one neuron and its activation, wherein one of untrainable input links and the untrainable links are excluded; and
adding the calculated weight changes to proper link weights, wherein the untrainable input links and the untrainable links are excluded.

13. The method for training a neuronal network in accordance with claim 9 for implementation in a computer program system, wherein the input and output values of the system are measured and a training data set for the neuronal network is established from the measured data, with these data being formed from a number of value pairs, each comprising four input values (α, Mα, η, q) and one output value (C_{M}).

14. The method of training, in accordance with claim 13, wherein the method of descent by degree is used.

15. The optimization process for adjusting the link weights of a neuronal network in accordance with claim 9 for implementation in a computer program system, wherein trainable link weights w_{y} are adjusted such that the neuronal network supplies an optimal output for all measured data, wherein the values for the inputs to the network are taken from the training data set, comprising:
assigning random values to the link weights;
setting the input links to the input values from the training data set;
calculating the network from the input layer up to the output layer, wherein the activation of each neuron is calculated independent of the preceding neurons and links;
comparing the activation of the output neurons with the reference value from the training data set, and calculating the network error from the difference;
calculating for each layer of the error at each neuron from the network error, against the longitudinal orientation, wherein the links function as inputs;
calculating the weight change in the links to adjacent neurons, dependent upon the error of one neuron and its activation;
adding the weight changes to the proper link weights, wherein the weight changes are not added to the untrainable links and the untrainable input links.

16. The optimization process for adjusting the link weights of a neuronal network in accordance with claim 15, wherein the link weights are set to random values within the range of [−1.0 to +1.0].

17. The optimization process for adjusting the link weights of a neuronal network in accordance with claim 15, wherein the optimization process is conducted for only one group in the neuronal network.
